(19) United States
(12) Patent Application Publication
(10) Pub. No.: US 2021/0004387 A1
(43) Pub. Date: Jan. 7, 2021

(54) CHANGING THE NUMBER OF REPLICAS OF A POD BASED ON SIZE OF MESSAGE QUEUE

(71) Applicant: HEWLETT PACKARD ENTERPRISE DEVELOPMENT LP, Houston, TX (US)

(72) Inventors: SHARAN CHAITANYA POTTURU, Bangalore (IN); Amit Kumar Kumar Gupta, Bangalore (IN); Monotosh Das, Bangalore (IN)

(21) Appl. No.: 16/775,175

(22) Filed: Jan. 28, 2020

Related U.S. Application Data
(60) Provisional application No. 62/870,598, filed on Jul. 3, 2019.

(51) Int. Cl. G06F 16/27

(52) U.S. Cl. CPC G06F 16/27

(57) ABSTRACT

Systems and methods are provided for changing the number of replicas of a pod based on the size of the message queue. A method may include determining a number of replicas of a pod; determining an owner threshold for a size of a message queue of the replicas of the pod, the size representing a number of messages waiting in the message queue to be processed by the replicas of the pod, the owner threshold being provided by an owner of the pod; occasionally determining, for the replicas of the pod, the size of the message queue, and a rate of change of the size of the message queue; and responsive to determining the size of the message queue, changing the number of replicas of the pod based on the determined size of the message queue, the determined rate of change, and the owner threshold.

### CROSS REFERENCE TO RELATED APPLICATIONS

The present application claims priority to U.S. Provisional Patent Application No. 62/870,598, filed Jul. 3, 2019, entitled “CHANGING THE NUMBER OF REPLICAS OF A POD BASED ON SIZE OF MESSAGE QUEUE,” the disclosure thereof incorporated by reference herein in its entirety.

### DESCRIPTION OF RELATED ART

The disclosed technology relates generally to distributed computing, and more particularly some embodiments relate to managing distributed computing resources.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates a pod system featuring horizontal pod autoscaling according to embodiments of the disclosed technology.

FIG. 2 is a block diagram of an example computing component or device for horizontal pod autoscaling in accordance with embodiments of the disclosed technology.

FIGS. 3 and 4 illustrate an example operation of an embodiment of the disclosed technology. FIG. 3 illustrates a previous state of a pod system, while FIG. 4 illustrates a current state of the pod system.

FIG. 5 depicts a block diagram of an example computer system in which embodiments described herein may be implemented.

The figures are not exhaustive and do not limit the present disclosure to the precise form disclosed.

### DETAILED DESCRIPTION

Advances continue to be made in the realm of computing virtualization. One recent advance involves the use of containers. A container may be a standard executable application image that includes both software and dependencies such as system libraries so the application may run quickly and reliably in different computing environments. One popular container is the Docker container.

To manage containers, a container orchestrator is employed. Popular container orchestrators include Docker Swarm and Kubernetes. Kubernetes manages containers using pods. A Kubernetes pod is a group of one or more containers with shared resources and having contents that are co-located and co-scheduled, and run in a shared context. A pod models an application-specific “logical host.”

To account for increased or decreased usage, a pod may be “horizontally scaled” by creating additional replicas of the pod or reducing the number of replicas. When implemented as a control loop, this technique is referred to as “horizontal pod autoscaling.”

Each group of pod replicas has a message queue containing messages assigned to the group but not yet processed by the group. Embodiments of the present disclosure may change the number of pod replicas based on the size of the message queue, the rate of change of the size of the message queue, an owner threshold specified by an owner of the pod, and the like.

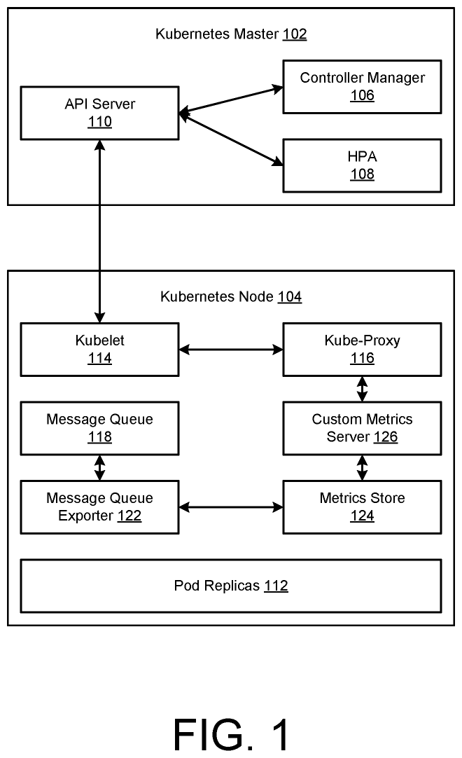

FIG. 1 illustrates a pod system featuring horizontal pod autoscaling according to embodiments of the disclosed technology. The pod system of FIG. 1 is described with reference to the Kubernetes system. However, it will be understood that the described technology may be applied with other container orchestrators and other container systems.

Referring to FIG. 1, the horizontal pod autoscaling system includes a Kubernetes master 102, and a Kubernetes node 104. Only one Kubernetes node 104 is shown and described. However, it will be understood that the disclosed technology may be applied to systems including multiple nodes.

The Kubernetes master 102 may include a controller manager 106 and a horizontal pod autoscaler (HPA) 108. The controller manager 106 and the HPA 108 may implement one or more of the functions described herein. The HPA 108 may be configured using a configuration file. The configuration file may be implemented, for example, as a yaml file. The configuration file may specify a maximum number of pod replicas, a minimum number of pod replicas, and the like.

The Kubernetes master 102 may include an application programming interface (API) server 110. The API server 110 may allow communication between the Kubernetes master 102 and the Kubernetes node 104. The API server 110 may also allow communication with other entities.

The Kubernetes node 104 may include one or more pod replicas 112. Each pod replica may implement one or more containers. Each container may implement an application. Each pod may be associated with an owner, for example such as a customer of the pod system.

Each Kubernetes node 104 may include a Kubelet 114. The Kubelet 114 may provide an interface between the Kubernetes node 104 and the Kubernetes master 102.

The Kubernetes node 104 may include a Kube-proxy 116. The Kube-proxy 116 may provide an interface between the custom metrics server 126 and the Kubelet 114. The Kube-proxy 116 may provide an interface for humans such as administrators, owners, and the like.

The Kubernetes node 104 may include a message queue 118. The message queue 118 may receive messages to be processed by the pod replicas 112, and may store those messages until they can be processed by the pod replicas 112. The message queue 118 may be characterized by a message queue size. The message queue size may represent a number of messages currently stored in the message queue 118. The message queue 118 may be characterized by a rate of change of the size of the message queue 118. The rate of change may be characterized by an ingress rate. The ingress rate may describe a rate at which messages are added to the message queue 118. The rate of change may be characterized by an egress rate. The egress rate may describe a rate at which messages are removed from the message queue 118 for processing by the pod replicas 112.

The Kubernetes node 104 may include a message queue exporter 122. The message queue exporter 122 may obtain data characterizing the message queue 118. For example, the message queue exporter 122 may obtain data characterizing a size of the message queue 118, a rate of change of the size of the message queue 118, and the like. The message queue exporter 122 may generate one or more usage metrics based on the data characterizing the message queue 118. The usage metrics may include any metrics that indicate the usage of the message queue 118, and may include some or all of the data characterizing the message queue 118, metrics derived from that data, or any combination thereof. The usage metrics may be based on a current size of the message queue 118, a previous size of the message queue 118, a rate of change of the size of the message queue 118, and the like.

The Kubernetes node 104 may include a metrics store 124. The metrics store 124 may include storage to store usage metrics generated by the message queue exporter 122. The message queue exporter 122 may store usage metrics in the metrics store 124. The metrics store 124 may be implemented, for example, as a Prometheus server.

The Kubernetes node 104 may include a custom metrics server 126. The HPA 108 of the Kubernetes master 102 may use the custom metrics server 126 to query the metrics store 124. The custom metrics server 126 may respond to such queries by providing stored usage metrics. The HPA 108 may employ the usage metrics to horizontally scale the pod replicas 112 in the pod system.

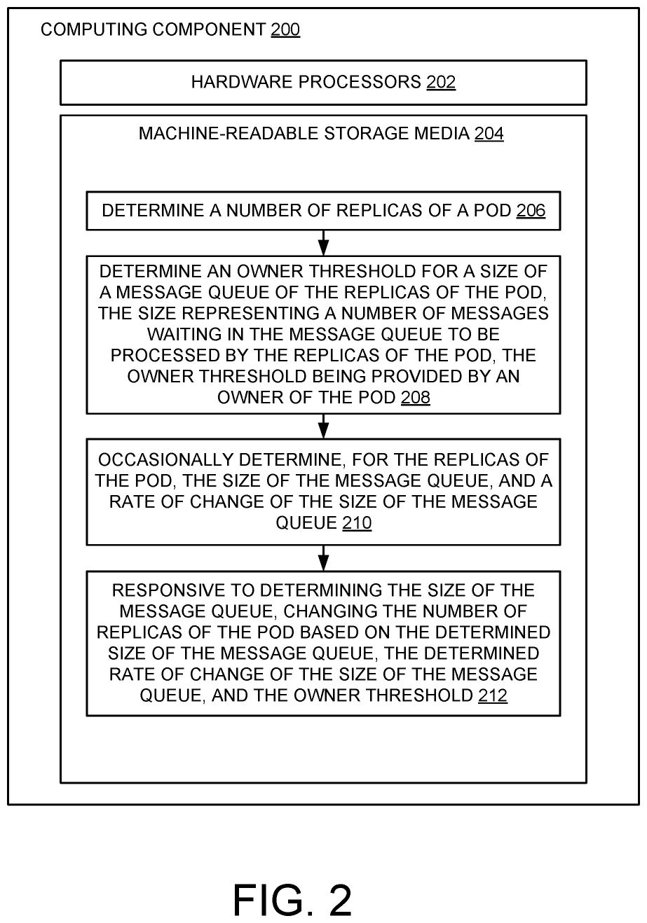

FIG. 2 is a block diagram of an example computing component or device 200 for horizontal pod autoscaling in accordance with embodiments of the disclosed technology. Computing component 200 may be, for example, a server computer, a controller, or any other similar computing component capable of processing data. In the example implementation of FIG. 2, the computing component 200 includes a hardware processor 202, and machine-readable storage medium 204. In some embodiments, computing component 200 may be an embodiment of the controller manager 106, the HPA 108, the message queue exporter 122, the custom metrics server 126, or any combination thereof.

Hardware processor 202 may be one or more central processing units (CPUs), semiconductor-based microprocessors, and/or other hardware devices suitable for retrieval and execution of instructions stored in machine-readable storage medium, 204. Hardware processor 202 may fetch, decode, and execute instructions, such as instructions 206-212, to control processes or operations for managing containers as described in accordance with various embodiments. As an alternative or in addition to retrieving and executing instructions, hardware processor 202 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 204, may be any electronic, magnetic, optical, or other physical storage device that contains or stores executable instructions. Thus, machine-readable storage medium 204 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 204 may be a non-transitory storage medium, where the term “non-transitory” does not encompass transitory propagating signals. As described in detail below, machine-readable storage medium 204 may be encoded with executable instructions, for example, instructions 206-212.

Hardware processor 202 may execute instruction 206 to determine a number of replicas 112 of a pod in the pod system. The number of replicas 112 may be stored in the Kubernetes master 102 or the Kubernetes node 104.

Hardware processor 202 may execute instruction 208 to determine an owner threshold for a size of a message queue 118 of the replicas 112 of the pod. The size may represent a number of messages waiting in the message queue 118 to be processed by the replicas 112 of the pod. The owner threshold may be provided by an owner of the pod 112. The owner threshold may be stored in the Kubernetes master 102 or the Kubernetes node 104.

Hardware processor 202 may execute instruction 210 to occasionally determine, for the replicas 112 of the pod, the size of the message queue 118, and a rate of change of the size of the message queue 118. For example, the HPA 108 may be configured to query the custom metrics server 126. The HPA 108 may send the queries occasionally. As used herein, the term “occasionally” means repeatedly over time, where the repetitions may be performed periodically, aperiodically, or any combination thereof. For example, the HPA 108 may send a query periodically, for example every two minutes. The API server 110 of the Kubernetes master 102 may forward the queries to the custom metrics server 126.

The custom metrics server 126 may maintain a local cache. The custom metrics server 126 may update the cache occasionally by querying the metrics store 124. For example, the custom metrics server 126 may query the metrics store 124 every two minutes. The metrics store 124 may update data stored therein by querying the message queue exporter 122. The message queue exporter 122 may respond by posting the data to the metrics store 124. The custom metrics server 126 may format the data according to a format that can be consumed by the HPA 108.

Hardware processor 202 may execute instruction 212 to, responsive to determining the size of the message queue 118, changing the number of replicas 112 of the pod based on the determined size of the message queue 118, the determined rate of change of the size of the message queue 118, and the owner threshold.

For example, the custom metrics server 126 may generate a usage metric based on the determined size of the message queue 118, and the determined rate of change of the size of the message queue 118. The HPA 108 may compare the owner threshold with the usage metric, and may change the number of replicas 112 of the pod based on the comparing.

The HPA 108 may increase the number of replicas 112 of the pod responsive to the usage metric being greater than the owner threshold. The HPA 108 may decrease the number of replicas 112 of the pod responsive to the usage metric being less than the owner threshold. In some embodiments, the HPA 108 may decrease the number of replicas 112 of the pod responsive to the usage metric being less than half the owner threshold.

The custom metrics server 126 may set the usage metric based on an egress rate of the message queue 118, an ingress rate of the message queue 118, or both. The custom metrics server 126 may set the usage metric to a determined value responsive to the determined size of the message queue 118 exceeding the determined value, and the egress rate of the message queue 118 being less than the ingress rate of the message queue 118. The determined value may be configurable. For example, the determined value may be set to 100.

The custom metrics server 126 may set the usage metric as a function of a determined value K, a current ingress rate (CIR) of the message queue 118, and a previous ingress rate (PIR) of the message queue 118. For example, the custom metrics server 126 may set the value of the usage metric UM according to equation (1). The determined value K may be configurable. For example, the determined value may be set to 100.

UM=K−((PIR−CIR)*100)/PIR) (1)

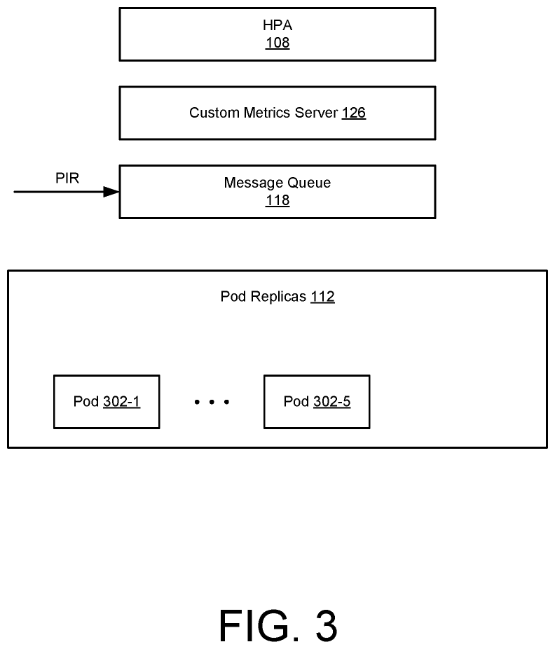

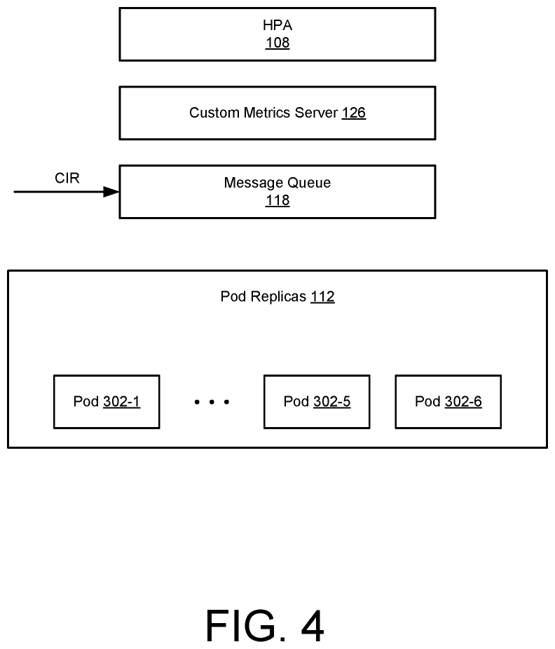

FIGS. 3 and 4 illustrate an example operation of an embodiment of the disclosed technology using this usage metric UM. FIG. 3 illustrates a previous state of a pod system, while FIG. 4 illustrates a current state of the pod system. The current state may refer to a time at which the custom metrics sever 126 determines a usage metric UM. The previous state may refer to a time prior to the current state.

Referring to FIG. 3, in the previous state, the pod replicas 112 include five replicas 302-1 through 302-5. And in the previous state, the message queue 118 receives messages at a previous ingress rate (PIR) of PIR=50 messages per second.

Referring to FIG. 4, in the current state, the message queue 118 receives messages at 8 current ingress rate (CIR) of CIR=60 messages per second. For this example operation, assume the determined value K=100. Then, applying equation (1), the custom metrics sever 126 determines the value of the usage metric UM as shown in equation (2).

UM=100−((50−60)*100)/50)=120 (2)

For this example, assume the value of the owner threshold OT is given by OT=100. Therefore, because UM>OT, the HPA 108 increases the number of replicas 112 of the pod 302 by one. In other examples, the HPA 108 may increase the number of replicas 112 of the pod 302 by more than one. Referring again to FIG. 4, the pod replicas 112 now include six replicas 302-1 through 302-6. In response to an increase of the ingress rate of the message queue 118, the pod system has increased the number of pod replicas.

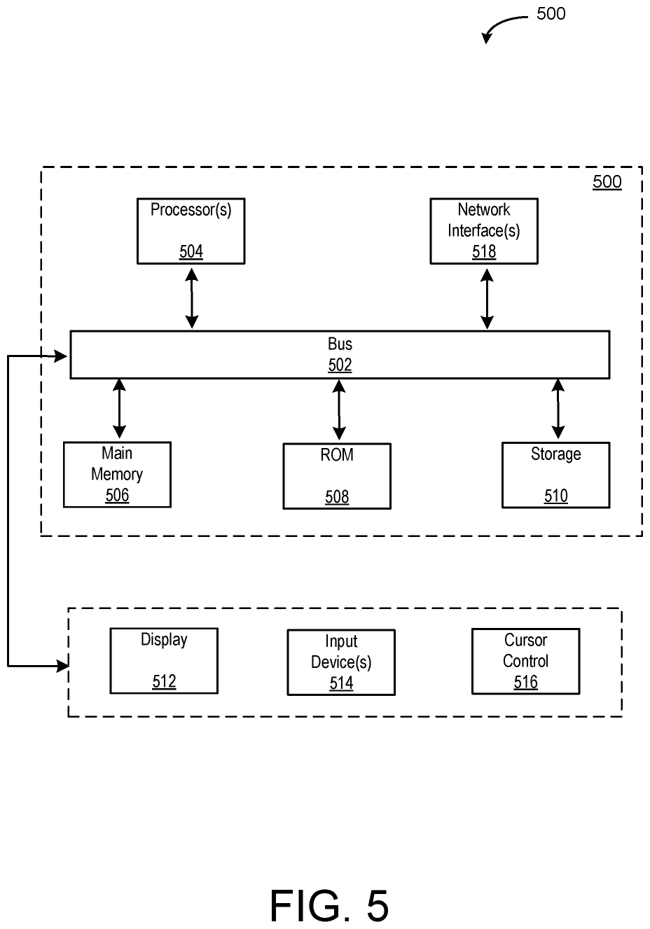

FIG. 5 depicts a block diagram of an example computer system 500 in which embodiments described herein may be implemented. The computer system 500 includes a bus 502 or other communication mechanism for communicating information, one or more hardware processors 504 coupled with bus 502 for processing information. Hardware processor(s) 504 may be, for example, one or more general purpose microprocessors.

The computer system 500 also includes a main memory 506, such as a random access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

The computer system 500 further includes a read only memory (ROM) 508 or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions.

The computer system 500 may be coupled via bus 502 to a display 512, such as a liquid crystal display (LCD) (or touch screen), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. In some embodiments, the same direction information and command selections as cursor control may be implemented via receiving touches on a touch screen without a cursor.

The computing system 500 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 506. Such instructions may be read into main memory 506 from another storage medium, such as storage device 510. Execution of the sequences of instructions contained in main memory 506 causes processor(s) 504 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 510. Volatile media includes dynamic memory, such as main memory 506. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 502. Transmission media can also take the form of acoustic or light waves, such as those generated during radio-wave and infra-red data communications.

The computer system 500 also includes a communication interface 518 coupled to bus 502. Network interface 518 provides a two-way data communication coupling to one or more network links that are connected to one or more local networks. For example, communication interface 518 may be an integrated services digital network (ISDN) card, cable modem, satellite modem, or a modem to provide a data communication connection to a corresponding type of telephone line. As another example, network interface 518 may be a local area network (LAN) card to provide a data communication connection to a compatible LAN (or WAN component to communicated with a WAN). Wireless links may also be implemented. In any such implementation, network interface 518 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 518, which carry the digital data to and from computer system 500, are example forms of transmission media.

The computer system 500 can send messages and receive data, including program code, through the network(s), network link and communication interface 518. In the Internet example, a server might transmit a requested code for an application program through the Internet, the ISP, the local network and the communication interface 518.

The received code may be executed by processor 504 as it is received, and/or stored in storage device 510, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 500.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system, comprising:
a hardware processor; and
a non-transitory machine-readable storage medium encoded with instructions executable by the hardware processor to perform a method comprising:
determining a number of replicas of a pod;
determining an owner threshold for a size of a message queue of the replicas of the pod, the size representing a number of messages waiting in the message queue to be processed by the replicas of the pod, the owner threshold being provided by an owner of the pod;
occasionally determining, for the replicas of the pod, the size of the message queue, and a rate of change of the size of the message queue; and
responsive to determining the size of the message queue, changing the number of replicas of the pod based on the determined size of the message queue, the determined rate of change of the size of the message queue, and the owner threshold.

2. The system of claim 1, further comprising:
generating a usage metric based on the determined size of the message queue, and the determined rate of change of the size of the message queue;
comparing the usage metric with the owner threshold; and
changing the number of replicas of the pod based on the comparing.

3. The system of claim 2, further comprising:
increasing the number of replicas of the pod responsive to the usage metric being greater than the owner threshold.

4. The system of claim 2, further comprising:
decreasing the number of replicas of the pod responsive to the usage metric being less than half the owner threshold.

5. The system of claim 1, wherein generating the usage metric comprises:
setting the usage metric based on at least one of an egress rate of the message queue and an ingress rate of the message queue.

6. The system of claim 5, wherein setting the usage metric comprises:
setting the usage metric to a determined value responsive to (i) the determined size of the message queue exceeding the determined value, and (ii) the egress rate of the message queue being less than the ingress rate of the message queue.

7. The system of claim 5, wherein setting the usage metric comprises:
generating the usage metric as a function of a current ingress rate of the message queue and a previous ingress rate of the message queue.

8. A non-transitory machine-readable storage medium encoded with instructions executable by a hardware processor of a computing component, the machine-readable storage medium comprising instructions to cause the hardware processor to perform a method comprising:
determining a number of replicas of a pod;
determining an owner threshold for a size of a message queue of the replicas of the pod, the size representing a number of messages waiting in the message queue to be processed by the replicas of the pod, the owner threshold being provided by an owner of the pod;
occasionally determining, for the replicas of the pod, the size of the message queue, and a rate of change of the size of the message queue; and
responsive to determining the size of the message queue, changing the number of replicas of the pod based on the determined size of the message queue, the determined rate of change of the size of the message queue, and the owner threshold.

9. The medium of claim 8, further comprising:
generating a usage metric based on the determined size of the message queue, and the determined rate of change of the size of the message queue;
comparing the usage metric with the owner threshold; and
changing the number of replicas of the pod based on the comparing.

10. The medium of claim 9, further comprising:
increasing the number of replicas of the pod responsive to the usage metric being greater than the owner threshold.

11. The medium of claim 9, further comprising:
decreasing the number of replicas of the pod responsive to the usage metric being less than half the owner threshold.

12. The medium of claim 8, wherein generating the usage metric comprises:
setting the usage metric based on at least one of an egress rate of the message queue and an ingress rate of the message queue.

13. The medium of claim 12, wherein setting the usage metric comprises:
setting the usage metric to a determined value responsive to (i) the determined size of the message queue exceeding the determined value, and (ii) the egress rate of the message queue being less than the ingress rate of the message queue.

14. The medium of claim 12, wherein setting the usage metric comprises:
generating the usage metric as a function of a current ingress rate of the message queue and a previous ingress rate of the message queue.

15. A method comprising:
determining a number of replicas of a pod;
determining an owner threshold for a size of a message queue of the replicas of the pod, the size representing a number of messages waiting in the message queue to be processed by the replicas of the pod, the owner threshold being provided by an owner of the pod;
occasionally determining, for the replicas of the pod, the size of the message queue, and a rate of change of the size of the message queue; and
responsive to determining the size of the message queue, changing the number of replicas of the pod based on the determined size of the message queue, the determined rate of change of the size of the message queue, and the owner threshold.

16. The method of claim 15, further comprising:
generating a usage metric based on the determined size of the message queue, and the determined rate of change of the size of the message queue;
comparing the usage metric with the owner threshold; and
changing the number of replicas of the pod based on the comparing.

17. The method of claim 16, further comprising:
increasing the number of replicas of the pod responsive to the usage metric being greater than the owner threshold.

18. The method of claim 16, further comprising:
decreasing the number of replicas of the pod responsive to the usage metric being less than half the owner threshold.

19. The method of claim 15, wherein generating the usage metric comprises:
setting the usage metric based on at least one of an egress rate of the message queue and an ingress rate of the message queue.

20. The method of claim 19, wherein setting the usage metric comprises:
setting the usage metric to a determined value responsive to (i) the determined size of the message queue exceeding the determined value, and (ii) the egress rate of the message queue being less than the ingress rate of the message queue.
